(19) United States
(12) Patent Application Publication
(10) Pub. No.: US 2014/0117697 A1
(43) Pub. Date: May 1, 2014

(54) UPPER DECK STORAGE SYSTEM

(71) Applicant: Daniel Danhoff, Mio, MI (US)

(72) Inventor: Daniel Danhoff, Mio, MI (US)

(21) Appl. No.: 13/661,073

(22) Filed: Oct. 26, 2012

(51) Int. Cl. B60P 1/00

(52) U.S. Cl. CPC B60P 1/00
USPC 296/26.13

(57) ABSTRACT

The present invention is a storage system for a pickup truck with an existing cap, topper or camper shell. The system is raised above the side panels of the pickup bed to utilize space that is wasted or unused. The system allows for cargo storage below. The system is capable of being used in a partial deployment, full deployment or stowed for future use. The system is anchored to the truck by four C clamps that secure the metal channels that support the panels of the invention. There are panels that slide securely into the metal channels affixing them to the channels. The user can now stow material above regular cargo utilizing space that was formerly wasted.

### BACKGROUND OF THE INVENTION

Capper organizers are not new to the art. In U.S. Pat. No. 6,283,526 entitled, “Pickup truck storage system”, issued to Keough, on Sep. 4, 2001 features an organizer that divides the bed area into an upper and lower layer with slide out drawer. This prior art does not concern itself with the addition of a capper shell and the wasted storage that is created by providing a covering for the bed area of a pickup truck. This failure to address the area created by the addition of a capper makes the present invention clearly more utilitarian.

In U.S. Pat. No. 6,832,798 entitled, “Pickup rack with elevated platform within canopy” issued to Krause, on Dec. 21, 2004 features platform that mounts over the pickup bed and within the canopy leaving an unobstructed view through the bed area. This platform is a permanent addition to the pickup, whereas the present invention has removable panels to allow immediate break down if condition require utilization of the entire space within the shell area.

In U.S. Pat. No. 8,162,367 entitled, “Rack with retractable drawer for the bed of a pickup truck” issued to Kuklok, on Apr. 24, 2012, features a rack with retractable drawers for the bed of a pickup truck including a rack that is supported by the sidewall of the truck bed. Once again the present invention has greater utility in that it is capable of be deployed and broken down completely freeing the bed area for any size cargo. The present invention also can be configured to be partially deployed allowing of use of more space if needed with only the removal on one or more panels.

### THE INVENTION

The present invention is a pickup storage system that has side wall mounting capabilities. The pickup storage system is comprised of a support channel. This support channel comprises a unitary elongated structure that has a front wall with a back side, a middle linear axis and a lower edge.

The support channel has fixedly attached perpendicularly to a plane of the back side of the unitary elongated structure, a bottom shelf.

This support channel has fixedly attached near the middle linear axis, a middle shelf, both shelves have a length essentially equal to the unitary elongated structure. There are at least two clamps per unitary elongated structure.

There also is at least two first variable width interlocking panels, each of which has outside edges, a bottom surface, a top surface, four corners, and a groove in at least one edge extending for the length of the panel.

There is also at least two second variable width interlocking panels that have outside edges, a bottom surface, a top surface, four corners, and each has a tongue on the outside edges. The tongue aligns with and insertable in the grooves of the first variable width interlocking panels.

All the panels have a depression near the outside edges and in the top surface thereof. This depression is essentially equal in length to the panels. Each panel has a male projection at the bottom surface in each corner.

### BRIEF DESCRIPTION OF THE DRAWINGS

FIG. 1 shows the pickup truck with the storage system in place.

FIG. 2 shows the C clamps of the storage system holding the support channels in place.

FIG. 3 shows end panel of the storage system.

FIG. 4 shows the main panel of the 3 panel configuration with dual tongue edges.

FIG. 5 shows an additional panel with a tongue and a groove on opposing edges.

FIG. 6 shows the storage system deployed within the bed of pickup through the topper or cap.

### DETAILED DESCRIPTION OF THE DRAWINGS

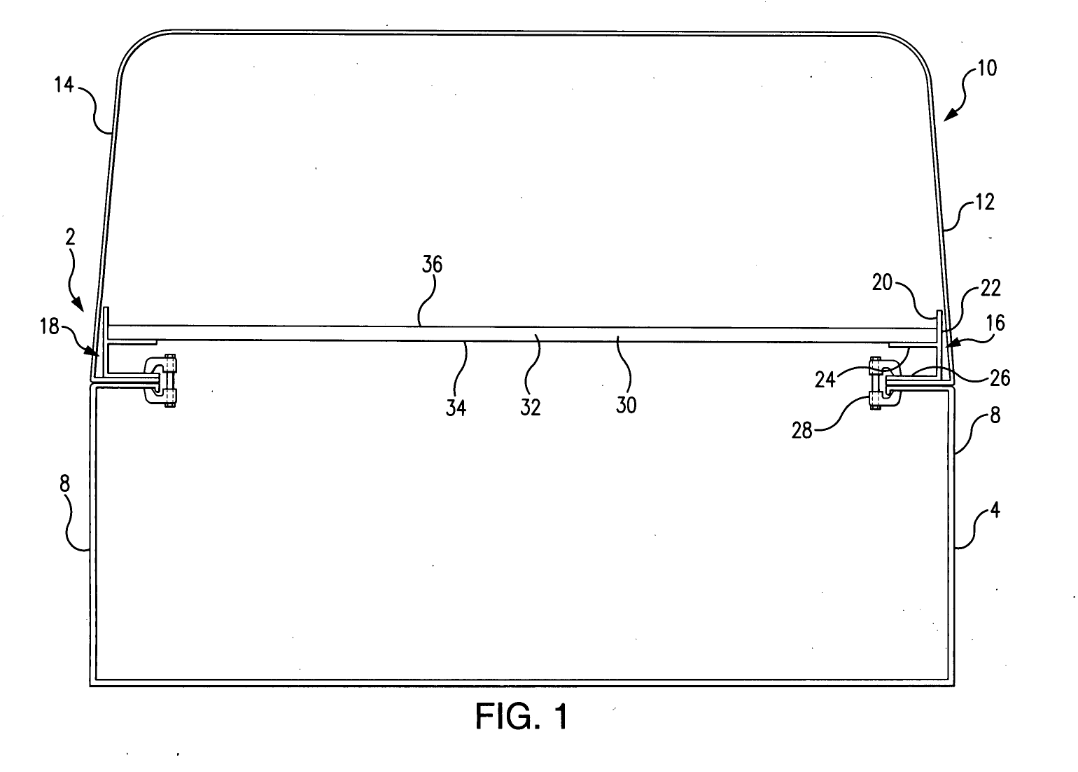

FIG. 1 shows the pickup truck with the storage system 2 in place. The storage system 2 anchors above the pickup truck bed 4. There are two C-clamps 28 that are secured to the pickup truck side walls 8 and the camper shell 10 securing each support channel 16, 18 firmly to the pickup truck bed walls 8 and the camper shell 10 side walls 12 and 14.

The support channels 16 and 18 have a front wall 20 and a back side 22. There is also a middle linear axis 24 that supports the interlocking panels 30. Each of the Panels has an outside edge 32, a bottom surface 34 and a top surface 36. The panels 30 are interlocking.

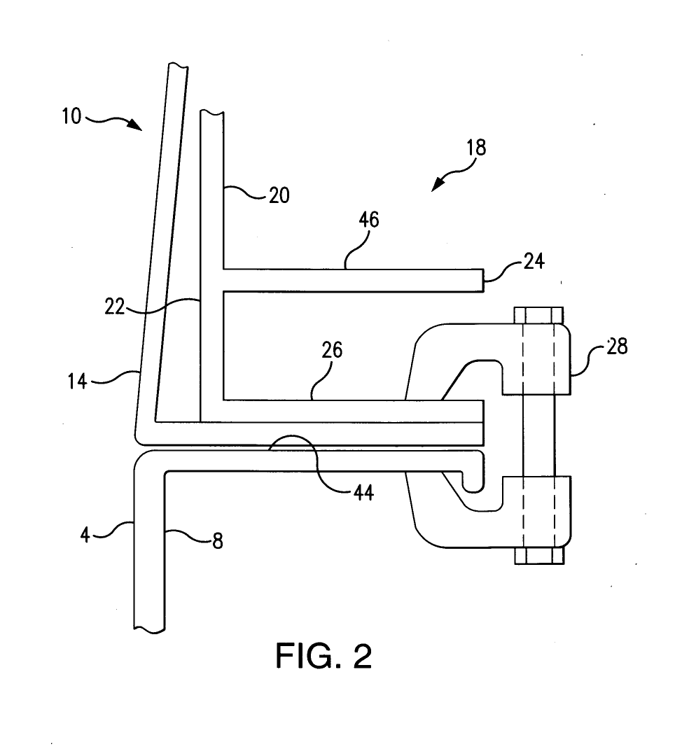

FIG. 2 shows the C-clamps 28 of the storage system 2 holding the support channels 16 and 18 in place. It is clear from this figure that the C-clamps 28 hold the support channels 16 and 18 securely to the top 44 of the side walls 8. It is also clear that the support channels 16 and 18 sit above the pickup truck side walls 8 allowing for cargo storage below the storage system 2. The figure shows the aspects of the support channels 16 and 18 in more detail. Each support channel 16, 18 have a front wall 20, a back wall 22 a middle linear axis 24 and a support 46.

The support 46 holds the interlocking panels 30 in place. It has been discovered that the panels 30 will stay in place if they are the appropriate length and sliding into position tightly.

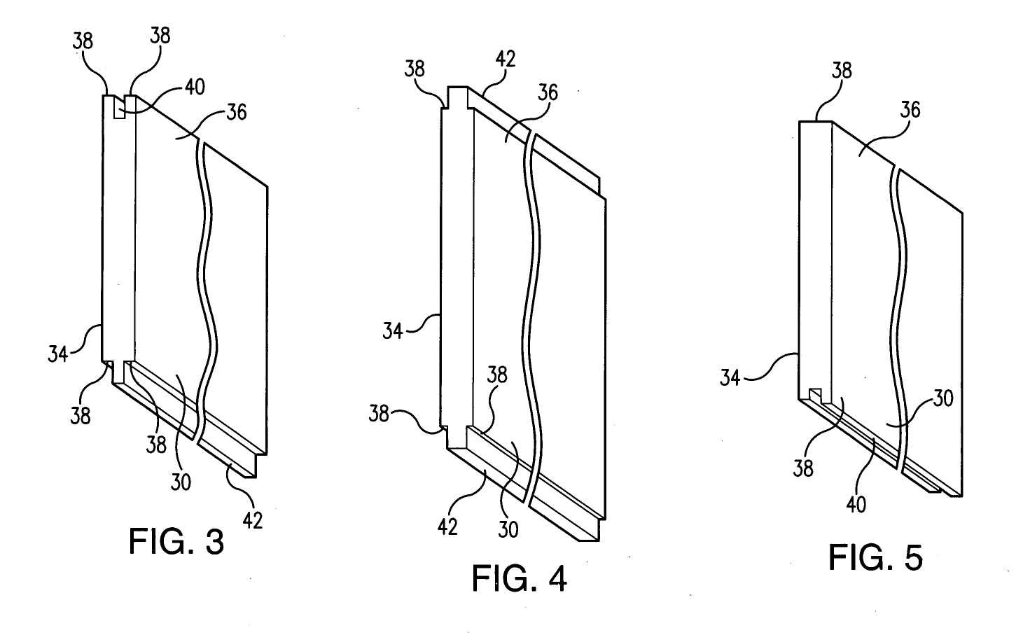

FIG. 3 shows an interlocking panel 30 of the storage system 2. The interlocking panels 30 have different configurations that allow the interlocking panels 30 to lock together. The interlocking panels 30 have multiple purposes. The first purpose has been discovered to allow the user to make a storage platform 2 of their choosing. Meaning they can customize the interlocking panel 30 configurations to accommodate the use of the interlocking panels 30 and still provide an area of the pickup bed for use in the carrying of larger items or complete use of the space from pickup bed 4 to the top of the capper 10.

Not only can the full height inside the capper 10 area be utilized, but the storage system 2 can be deployed to a length of one interlocking panel 30 or can run the full length of the pickup bed 4 giving the user the use of the bed 4 and another level the same length or the full length of the pickup bed 4. Each of the interlocking panels 30 has a top surface 36, a bottom surface 34 and four corners 38. One skilled in the art understands the use and configuration of the tongue 42 and groove 40 connection. This particular interlocking panel 30 features both a tongue 42 portion and a grooved 40 portion.

FIG. 4 shows the main interlocking panel 30 of a 3 panel configuration with dual tongue 42 edges. This interlocking panel 30 can be used between two end interlocking panels 30 to make a 3 interlocking panel configuration. Each of the interlocking panels 30 have top surface 36, a bottom surface 34 and four corners 38. One skilled in the art understands the use and configuration of the tongue 42 and groove 40 connection and this particular interlocking panel 30 has a two tongue 42 portions.

FIG. 5 shows an additional interlocking panel 30 with a tongue 42 and a groove 40 on opposing edges. This interlocking panel 30 is a beginning or an end panel 30. Each of the interlocking panels 30 has a top surface 36, a bottom surface 34 and four corners 38. One skilled in the art understands the use and configuration of the tongue 42 and groove 40 connection and this particular interlocking panel has a one groove 40 portion and a flat end 48. This is an end panel 30.

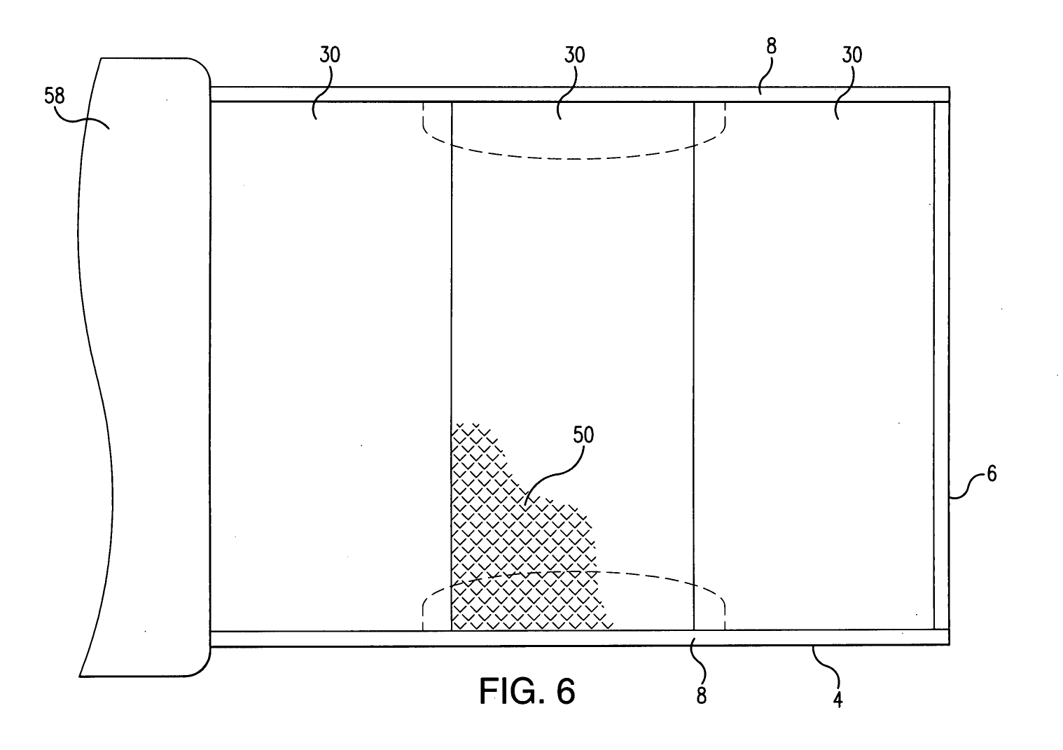

FIG. 6 shows the storage system 2 deployed within the bed 4 of pickup through the topper or cap 10. The interlocking panels 30 have been arranged to form a shelf structure that rests above the bed 4 of the pickup. This enables the user to still use the bed area 4 for cargo storage and utilize the space above that is usually wasted. The storage system 2 is capable for running the full length of the bed 4 from the pickup cab 58 to the tail gate 6.

The top surface 36 of the interlocking panels 30 can be treated with a non-slip material 50 to prevent articles from moving around during transportation.

It should also be clear from this figure that the user can determine how many interlocking panels 30 need to be deployed. The user can deploy one interlocking panel 30, two interlocking panels 30 or more depending on the need of the user.

Again, if the user has large items they can still use the interlocking panels 30 and leave an area of bed 4 open to the top of the cap 10 for these larger items and still be able to utilize the storage system 2.

It has been discovered that the present invention allows the user to erect a storage system 2 that is also removable. This allows the user a greater degree of flexibility in its use. The storage system 2 can be erected and then removed within minutes allowing the user to have a great deal of flexibility in its use.

What is claimed is:

1. A pickup storage system having side wall mounting capabilities, said pickup storage system comprising:
a. a support channel, said support channel comprising a unitary elongated structure having a front wall with a back side, a middle linear axis and a lower edge;
b. said support channel having fixedly attached perpendicularly to a plane of the back side of the unitary elongated structure, a bottom shelf;
c. said support channel having fixedly attached near the middle linear axis, a middle shelf, both shelves having a length essentially equal to the unitary elongated structure;
d. at least two clamps per unitary elongated structure;
e. at least two first variable width interlocking panels, each having outside edges, a bottom surface, a top surface, four corners, and a groove in at least one edge extending for the length of the panel;
f. at least two second variable width interlocking panels having outside edges, a bottom surface, a top surface, four corners, and each having a tongue on said outside edges, said tongue aligning with and insertable in said grooves of the first variable width interlocking panels;
g. all said panels having a depression near the outside edges and in the top surface thereof, said depression being essentially equal in length to said panels, each said panel having a male projection at the bottom surface in each corner.
